(19) United States
(12) Patent Application Publication
(10) Pub. No.: US 2008/0070205 A1
(43) Pub. Date: Mar. 20, 2008

(54) Methods, systems, and computer program products for adjusting readability of reading material to a target readability level

(75) Inventors: Thomas Larry Amick, Chapel Hill, NC (US); Charles Ray Grissom JR., Raleigh, NC (US); Llewellyn G. Brown, Chapel Hill, NC (US)

Correspondence Address: JENKINS, WILSON, TAYLOR & HUNT, P. A., 3100 TOWER BLVD., Suite 1200, DURHAM, NC, 27707, US

(73) Assignee: Understanding Corporation, Inc.

(21) Appl. No.: 11/810,698

(22) Filed: Jun. 6, 2007

Related U.S. Application Data
(60) Provisional application No. 60/814,294, filed on Jun. 16, 2006.
(60) Provisional application No. 60/814,295, filed on Jun. 16, 2006.

(51) Int. Cl. G09B 17/00

(52) U.S. Cl. 434/178; 235/375; 704/251

(57) ABSTRACT

Systems, methods, and computer program products for adjusting readability of reading material to a target readability level are disclosed. According to one aspect, a method includes receiving reading material and a target readability level. First and second readability measures associated with the reading material can be determined. The method can also include determining a target value corresponding to at least one of the first or second readability measure. The target value determination can be based on the target readability level and the other of the first and second readability measures. A parameter or portion of the reading material can be identified that is associated with the first or second readability measure and that has an actual readability value with a predetermined relationship with the target value.

### RELATED APPLICATIONS

The presently disclosed subject matter claims the benefit of U.S. Provisional Patent Application Ser. No. 60/814,294, filed Jun. 16, 2006, and U.S. Provisional Patent Application Ser. No. 60/814,295, filed Jun. 16, 2006, the disclosures of which are incorporated herein by reference in their entireties.

### TECHNICAL FIELD

The subject matter disclosed herein relates generally to adjusting readability of reading material. More particularly, the subject matter disclosed herein relates to adjusting readability of reading material to a target readability level.

### BACKGROUND

The development of computers and communications networks has brought about the ability to easily communicate and store reading materials. Additionally, communications networks, such as the Internet, have enabled the storage and availability of massive amounts of reading materials and related data. Businesses have benefited greatly by the ability to easily communicate documents and make documents readily available to employees, clients, and other business associates.

Although advances have been made for increasing the availability of reading material, a remaining disabler of communications is the matching of the readability of reading materials to the reading level of its intended audience. In other words, it is important that a reader is able to understand the reading material. The matching of the readability of reading material to its reader's capability is particularly important to organizational effectiveness in a business environment.

Computer software has been developed for assessing the reading level of a person. Such software works by presenting reading material to a person and by testing the person's comprehension of the reading material. Additionally, computer software has been developed for evaluating the readability of a document and for revising a document to a target readability level. In this way, a document can be revised to a reading level suitable for the intended audience. However, the use of this computer software for document revisions has been difficult and time consuming. For example, when revising a document to a target readability level, a user must iteratively revise or adjust the document and request reassessment of the document until the target readability level is achieved. It would be beneficial to provide improved techniques for adjusting documents to a reading level suitable for a target audience.

### SUMMARY

According to one aspect, the subject matter described herein comprises systems, methods, and computer program products for adjusting readability of reading material to a target readability level. One method can include receiving reading material and a target readability level. Next, first and second readability measures associated with the reading material can be determined. The method can also include determining a target value corresponding to the first or second readability measure. The target value determination can be based on the target readability level and the other of the first and second readability measures. A parameter or portion of the reading material can be identified that is associated with the first or second readability measure and that has an actual readability value with a predetermined relationship with the target value.

According to one aspect, a method for adjusting readability of a plurality of reading materials to a target reading level is disclosed. The method can include receiving a set of reading materials. A reading level of a target audience can be determined. A readability level of each of the reading materials can be compared to the reading level of the target audience. Further, the method can include identifying at least one of the reading materials with a readability level having a predetermined relationship with the reading level of the target audience.

### BRIEF DESCRIPTION OF THE DRAWINGS

Exemplary embodiments of the subject matter will now be explained with reference to the accompanying drawings, of which:

FIG. 1 is an exemplary block diagram of a computer system for adjusting readability of reading material to a target readability level according to an embodiment of the subject matter described herein;

FIG. 2 is a flow chart of an exemplary process for adjusting readability of reading material to a target readability level in accordance with an embodiment of the subject matter described herein;

FIG. 3 is a flow chart of an exemplary process for aligning the readability of a set of reading materials to a predetermined target audience reading level in accordance with an embodiment of the subject matter described herein;

FIG. 4 is a screen display image of a list of a reading material set that can be presented to a user in accordance with the subject matter described herein;

FIG. 5 is a screen display image of a set of reading materials and their corresponding importance according to an embodiment of the subject matter described herein;

FIG. 6 is a screen display image of a list of people that can be selected in accordance with the subject matter described herein;

FIG. 7 is a screen display image of a name of a group of people and associated target audience reading level according to an embodiment of the subject matter described herein;

FIG. 8 is a screen display image of members of the group that can be edited by a user according to an embodiment of the subject matter described herein;

FIG. 9 is a screen display image of a comparison of reading material to a group and its members in accordance with the subject matter described herein;

FIG. 10 is a screen display image showing identifying portions of reading material that may be revised for adjusting a readability level according to an embodiment of the subject matter described herein;

FIG. 11 is an exemplary slice plotting graph according to an embodiment of the subject matter described herein;

FIG. 12 is an exemplary moving slice average graph according to an embodiment of the subject matter described herein; and

FIG. 13 is an exemplary standard deviation chart according to an embodiment of the subject matter described herein.

### DETAILED DESCRIPTION

The subject matter disclosed herein is directed to systems, methods, and computer program products for adjusting readability of reading material to a target readability level. Reading material can include, but is not limited to, electronic and hard copy text materials, books, manuals, magazines, newspapers, word process documents, web page documents, email, and the like. By use of the subject matter disclosed herein, such reading material may be adjusted to a specified target readability level by prompting and assisting a user to revision of identified portions and parameters of the documents.

According to one aspect, systems, methods, and computer program products disclosed herein may be utilized for adjusting the readability of a set of reading materials to a specified target audience reading level. The set of reading materials can be adjusted by identifying which of the reading materials and/or portions of the reading materials in the set that can be revised to achieve the target audience reading level. The reading materials may then be revised by a user to achieve the specified target audience reading level.

A readability level for reading material can be determined by a suitable formula or process which may depend on various basic readability measures such as average sentence length of the reading material, average word frequency compared to a standard corpus, average number of syllables in a word, average number of grammatical errors per sentence, and the like. In accordance with the techniques described herein, reading material and a specified target readability level are received for use in identifying parameters or portions of the reading material associated with readability measures and having actual readability values with predetermined relationships with the target readability level. The reading material may be scanned for identifying words and/or sentences that can be revised to result in the target readability level. After revisions are made to the reading material, the process can be applied repeatedly to identify further potential revisions. This iterative process can be executed until the target readability level is achieved.

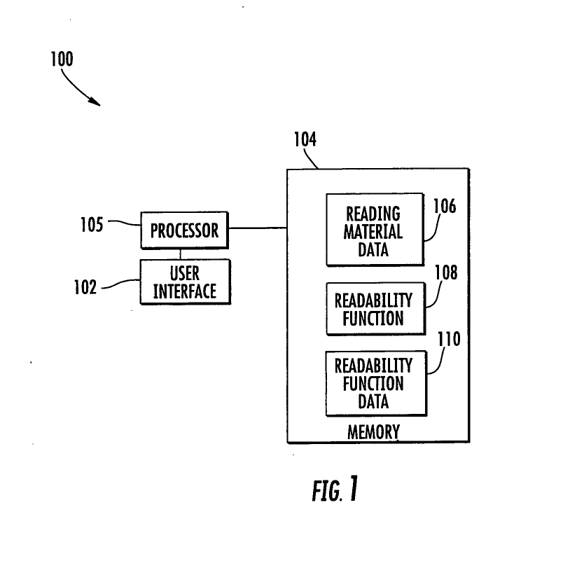

According to one aspect, a system for adjusting readability of reading material to a target readability level may be implemented as hardware, software, and/or firmware components executing on or with one or more modules of a system operable to receive and store reading material. FIG. 1 illustrates an exemplary block diagram of a computer system generally designated 100 for adjusting readability of reading material to a target readability level according to an embodiment of the subject matter described herein. Computer system 100 may be any suitable system for storing reading material, such as a personal computer (PC), a mobile phone, a personal digital assistant (PDA), and the like. The reading material may be in a digital format or any other suitable format that can be analyzed by a computer system. Computer system 100 may execute document software for receiving reading material and storing images in a memory.

As used herein, the term “reading material” refers to any material containing human-readable content, such as text. Examples of reading material include a document, a book, a manual, speech text, or any non-electronic hard copy material. Reading material can be a text document produced in electronic form by typing into a keyboard of a computer using a text editor or word processor. For example, reading material may include a markup language document (e.g., a hypertext mark-up language (HTML) web page), text embedded in a markup language document, an email, and the like. Alternatively, reading material can be in a hard copy format that is received by scanning reading material with an optical character recognition device. Further, reading material may be input by speech into a speech recognition device or program.

As used herein, the term “readability” refers to the reading difficulty level of the text in reading material. Several readability formulas or processes may be used for determining a readability level of reading material. Such readability formulas or processes may utilize mathematical formulas and/or computer or manual processes. In such processes, text of the reading material may be scanned and analyzed to determine readability using suitable standards and measures such as, but not limited to, those described herein.

As used herein, the term “readability measure” refers to any suitable measure of the readability of text in reading material. Examples of readability measures include number of syllables in a word and/or sentence, number of grammatical errors (e.g., the number or proportion of sentences having grammatical errors), number or proportion of misspelled words, number or proportion of unfamiliar words (as defined by a word list that identifies unfamiliar words in any suitable manner), number or proportion of inappropriate or misused words, and the like. Another exemplary readability measure can include the total number of paragraphs, sentences, and/or words in the reading material. Yet another exemplary readability measure can include the total number or proportion of foreign language words (as defined by a word list which identifies foreign language words) in the reading material. Another exemplary readability measure can include any standard or measure of correct or incorrect punctuation. Another exemplary readability measure can include any count or proportion of included or missing punctuation. Another exemplary readability measure can include any count or proportion of “white space,” such as, but not limited to, spaces, tabs, carriage returns, line feeds, new lines, and the like. Another exemplary readability measure can include any count or proportion of non-textual elements, such as, but not limited to, images, pictures, diagrams, colors, fonts, and the like. Another exemplary readability measure can include any measure of writing style, such as, but not limited to, active versus passive voice, narrative, sentence structure, paragraph structure, essay structure, grammatical correctness, correct or incorrect word use, and the like. In another example, a readability measure may include a number or proportion of familiar words as defined by a word list which identifies familiar words, such as a Dale-Chall list and a list of common words for English as a second language. In another example, a readability measure may include word frequency such as an average word frequency as determined by a list of words and their frequencies, which may be determined by any suitable means, such as, but not limited to, an analysis of a standard corpus of documents, books, manuals, or any other text. In yet another example, a readability measure may include sentence length such as, but not limited to, an average number of words in a sentence, a number or proportion of sentences exceeding a specified sentence length, or are ranked by a set of specified sentence lengths. In another example, a readability measure may include a number or proportion of paragraphs or passages which exceed a specified length, or are ranked by a set of specified lengths. Additional examples include total number of grammatical errors, average number of grammatical errors per sentence, total number of misspelled words, percentage of misspelled words, number of sentences in the passive voice, number of sentences with multiple clauses, number of previously identified phrases or words that are to be avoided, and any other quantitative measure of the text or language content.

A readability level of reading material can be determined based on a scan of the text of the reading material. For example, the text may be scanned to calculate the average sentence length of each sentence in words, the average frequency or commonality measure for each word from a word frequency index or standard corpus, and the average number of syllables in each word. A formula or process for determining the readability level can use the resulting averages and calculate the readability level. Exemplary readability formulas or processes include the Flesch Readability Index, the Flesch-Kincaid Grade Level, the Fog Index, the Bormuth Grade Level Readability Score, the Lexile Framework for Reading, and the like. A readability level as described herein can be calculated using any of these exemplary formulas or processes.

In the examples provided herein, it is assumed that the readability level is based on numbers, and that lower numeric levels indicate more readable text. Therefore, decreasing readability levels correlate to increasing readability. If a subject readability system or process provides for readability levels that are scored in such a manner such that higher scores correspond to more readable text, then the readability level/scale of the subject system or process is reversed by multiplying the level calculated and reported by that readability system by −1 (i.e., negative one). Thus, the subject matter described herein may be applied to any readability scale, whether increasing or decreasing. Although it is assumed herein that the readability level is based on numbers, any other suitable indicia may be used for indicating the readability level of reading material.

Computer system 100 may include a user interface 102 by which a user inputs data. For example, user interface 102 may include a keyboard, a keypad, a touch screen interface, a tablet PC interface, or a mouse. The user can input commands into user interface 102 to identify reading material for adjustment to a target readability level. Further, user interface 102 may be used for entering the target readability level. User interface 102 may also include a display for displaying the reading material to the user. Further, user interface 102 may receive user commands for controlling communication of the reading material to a remote destination, such as another computer system.

Further, computer system 100 may include a memory 104 configured for storing, at least temporarily, data and programs. Memory 104 can include any suitable type of data storage in the form of devices, tapes, or disks. Memory 104 can also include any suitable type of physical memory, such as computer chips capable of storing data. Physical memory can also include a computer's main memory or random-access memory (RAM), read-only memory (ROM), programmable read-only memory (PROM), erasable programmable read-only memory (EPROM), and electrically erasable programmable read-only memory (EEPROM). A processor 105 may be configured for executing instructions stored in memory 104 and interfacing with user interface 102.

Memory 104 may receive and store reading material and a target readability level. Additionally, memory 104 may store computer executable instructions configured for implementing the subject matter described herein. The subject matter described herein can be implemented as any suitable computer program product comprising computer executable instructions embodied in a computer readable medium. Exemplary computer readable media suitable for implementing the subject matter described herein include disk memory devices, chip memory devices, application specific integrated circuits, programmable logic devices, and downloadable electrical signals. In addition, a computer program product that implements the subject matter described herein may be located on a single device or computing platform. Alternatively, the subject matter described herein can be implemented on a computer program product that is distributed across multiple devices or computing platforms.

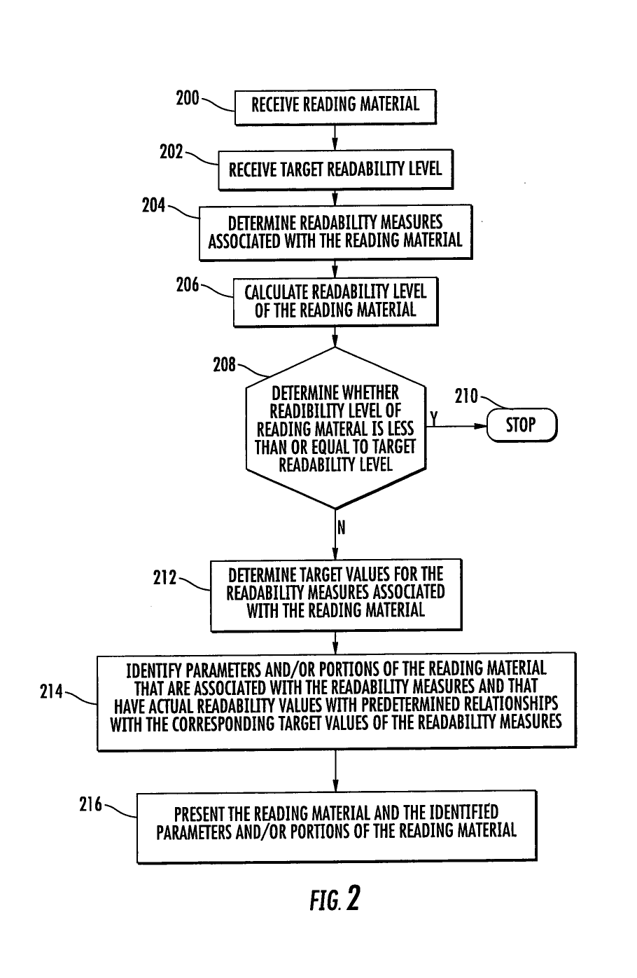

FIG. 2 is a flow chart illustrating an exemplary process for adjusting readability of reading material to a target readability level in accordance with an embodiment of the subject matter described herein. This exemplary process is described with reference to computer system 100 shown in FIG. 1. Referring to FIGS. 1 and 2, in block 200, reading material is received by memory 104. The reading material may be a document input by a user with user interface 102. Alternatively, for example, the reading material may be a document received over a network connection or received from a computer readable media, such as a disk. The reading material may be stored as reading material data 106 in memory 104. Further, for example, the document may be received in any suitable form and converted to electronic format for purposes of analysis.

In block 202, a target readability level is received by memory 104. The target readability level can be represented by a data value, such as a number. The data value can be received and stored by a readability function 108 in memory 104 as part of readability function data 110. The target readability level may be input by a user with user interface 102. Alternatively, for example, the target readability level may be a value received over a network connection or received from a computer readable media, such as a disk.

Readability function 108 may determine readability measures associated with the readability material (block 204). The following equation can be used for indicating a readability formula or process by which readability measures can be determined:
r=f(x1, x2, x3, . . . , xn) (1)
In this equation, the variables x1, . . . , xn represent the basic readability measures as described above, such as average sentence length, average word frequency, average number of syllables in a word, and the like. The value r given by equation (1) is assumed to be such that decreasing values of r correspond to more easily read text.

The subject matter described herein can be applied to any suitable readability formula or process which conforms to equation (1) for any number of independent basic readability measures. For example, the Flesch-Kincaid reading level is provided by the formula r=f(x1, x2), where x1 is the average sentence length, and x2 is the average number of syllables in a word. The value r in this case represents the grade level of the text, such that lower levels indicate more easily read (more readable) text.

In one example of determining readability measures associated with readability material, readability function 108 can scan reading material data 106 and calculate basic readability measures x1, x2, . . . xn in accordance with readability measures defined by a predetermined set of rules.

In block 206, readability function 108 calculates a readability level R of the reading material. For example, the readability level R can be calculated based on the calculated basic readability measures x1, x2, . . . xn. The readability level of the reading material may be a numeric value.

In block 208, readability function 108 can determine whether the readability level R of the reading material is less than or equal to the target readability level. If it is determined that the readability level R is less than or equal to the target readability level, the process can stop (block 210) because the reading material is within an acceptable readability range.

Target values can be determined for the readability measures associated with the reading material (block 210). For each of the readability measures associated with the reading material, a target value Xk is determined based on the other values of the readability measures by finding the target value Xk which satisfies the following equation (2), where TR represents the target readability level:
TR=f(x1, x2, . . . , x(k−1), Xk, x(k+1), . . . , xn) (2)
In other words, for a fixed value for the target readability level and for each of the readability measures except Xk, the equation includes solving for the single unknown value Xk. In one example, Xk can be solved iteratively by trial and error. Other examples for finding a value for Xk include a linear search technique, a bisection algorithm, or by any other suitable technique.

In block 214, readability function 108 can identify parameters and/or portions of the reading material that are associated with the readability measures and that have actual readability values with predetermined relationships with the corresponding target values of the readability measures. Particularly, in one example, readability function 108 can identify parameters and/or portions of the reading material that have an actual readability value that is greater than the target value of the corresponding readability measure. These parameters and/or portions are identified as causing the reading material to not meet the target readability level. Thus, these parameters or portions of the reading material may be revised for adjusting the readability level of the reading material to a value within an acceptable range of the target readability level.

Portions of the reading material that may be identified includes a sentence, a word, a paragraph, punctuation, or any other measured or measurable part of the reading material. In one example, a readability measure may be the average sentence length. Sentences in the reading material having a length that exceeds the target value for sentence length may be identified. These sentences may then be shortened such that the readability level of the reading material is adjusted to a value less than the target readability level.

In another example of identifying portions of the reading material, a readability measure may be average word frequency. In this example, a word in the reading material may be identified that has a word frequency less than the target value for word frequency. These words may then be changed such that the readability level of the reading material is adjusted to a value less than the target readability level.

Examples of identifiable reading material parameters include a number of grammatical errors contained in the reading material, number of misspelled words, number of phrases or sentences in the passive voice, number of previously identified phrases or words that are to be avoided, and any other quantitatively measurable feature of the text.

In block 216, the reading material and the identified portions of the reading material can be presented to a user. For example, a text editor or a word processing program may display the reading material to a user on a display of user interface 102. Readability function 108 may control the text editor or the word processing program to highlight, annotate, or otherwise provide indicia for indicating the identified portion of the reading material. Thus, a user may quickly look at the reading material and determine the portions of the reading material that could be revised to adjust the reading material to a value less than the target readability level. The user may then provide input into user interface 102 for revising the identified portion of the reading material. After a user revises the reading material, the process can again be applied to the reading material to identify other suggested revisions to portions and/or parameters of the reading material. The user may continue to revise the identified portions of the reading material until the reading material is within an acceptable range of the target readability level.

The systems, methods, and computer program products described herein can be utilized for aligning the readability of a set of reading materials to a specified target audience reading level. Particularly, a set of reading materials can be aligned by identifying which of the reading materials and/or portions of the reading materials in the set that can be revised to achieve the target audience reading level. In one example, the reading level of a target audience can be measured by a reading test given to each person in the target audience. Next, the reading level of the target audience can be computed by averaging the reading levels of each person or by estimating the reading level of the target audience as a group. The readability level of the reading materials and the reading level of the target audience should be on the same scale, or have a comparability formula so that the levels can be compared using the same scale. A prioritized listing or identification of the reading materials in the set to be revised to the target audience readability level can be determined based on the set of reading materials, the computed readability levels for each of the reading materials, a user-defined numeric importance weight or measure for each of the reading materials, and the measure or estimated reading levels of the audience. The reading materials may be revised by the user to achieve the target audience readability level for the reading material set. The revisions can be continually applied to achieve the target audience readability level.

The reading level of a person may be measured based on any suitable technique. Exemplary reading level tests for determining a reading level on a numeric scale include the Lexile Framework for Reading and the Degrees of Reading Power measure. In addition, the reading level of each person in the audience may be estimated using scores on other types of tests, such as, but not limited to, a SCHOLASTIC APTITUDE TEST (SAT)® test (available from The College Board Headquarters of New York City, N.Y.), a GRADUATE RECORD EXAMINATIONS® test (available from Educational Testing Service of Princeton, N.J.), advanced placement (AP) scores, and the like. The reading level of each person in the audience may also be estimated by the highest grade level or degree obtained, or by any other convenient and reliable means.

The readability measure applied to the reading materials in the set can produce a readability level that can be compared to the measured or estimated reading levels of the people in the target audience using any suitable comparison formula or process. Thus, the measured readability level of the reading material and the measured or estimated reading level of the people in the audience can be compared using the same scale.

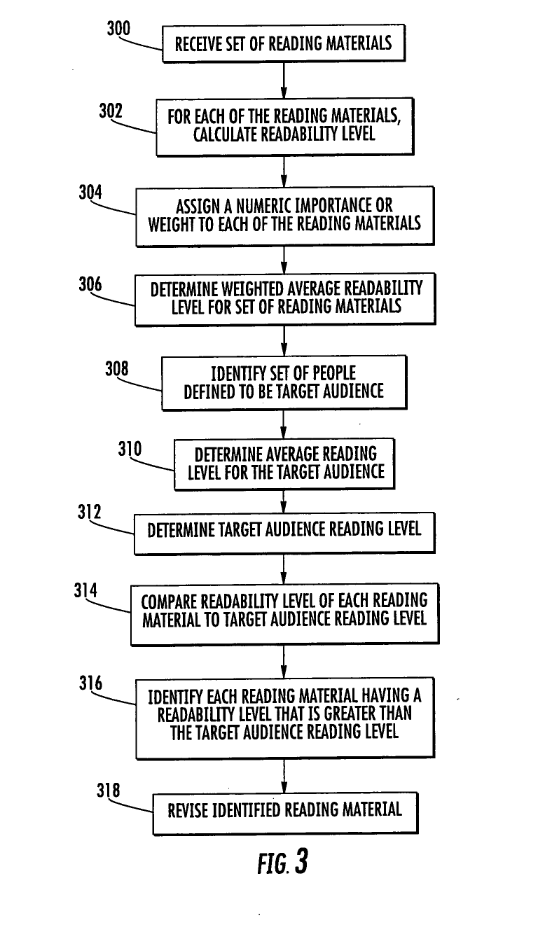

FIG. 3 is a flow chart illustrating an exemplary process for aligning the readability of a set of reading materials to a predetermined target audience reading level in accordance with an embodiment of the subject matter described herein. This exemplary process is described with reference to computer system 100 shown in FIG. 1. Referring to FIGS. 1 and 3, in block 300, a set of reading materials is received by memory 104. The set of reading materials may be produced in electronic form by typing in using a text editor or word processor or other suitable technique, browsing for, downloading, or otherwise transferring documents into a computer memory. Alternatively, the set of reading materials may be obtained by scanning documents, books, manuals, or any other non-electronic hard copy forms with an optical character recognition device or program, or by any other suitable technique.

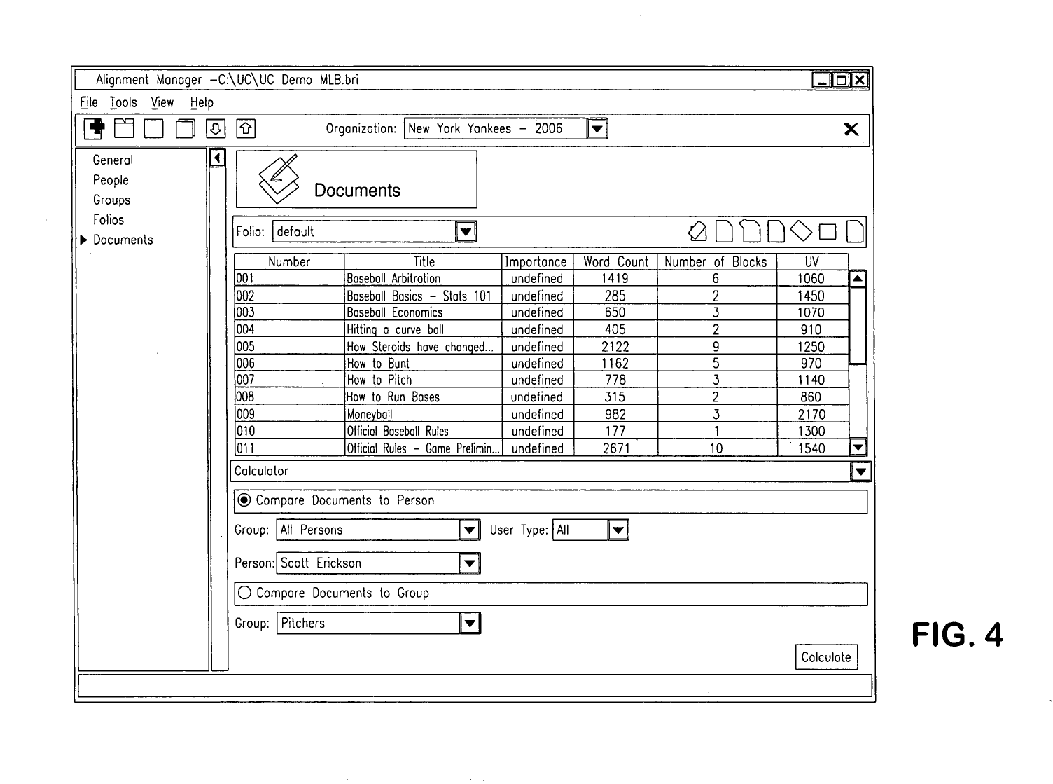

A list of the set of reading materials can be presented to a user via user interface 102. FIG. 4 is a screen display image of a list of a reading material set that can be presented to a user in accordance with the subject matter described herein.

In block 302, readability function 108 calculates a readability level R for each of the reading materials in the set. For example, the readability level R can be calculated based on the calculated basic readability measures x1, x2, . . . xn.

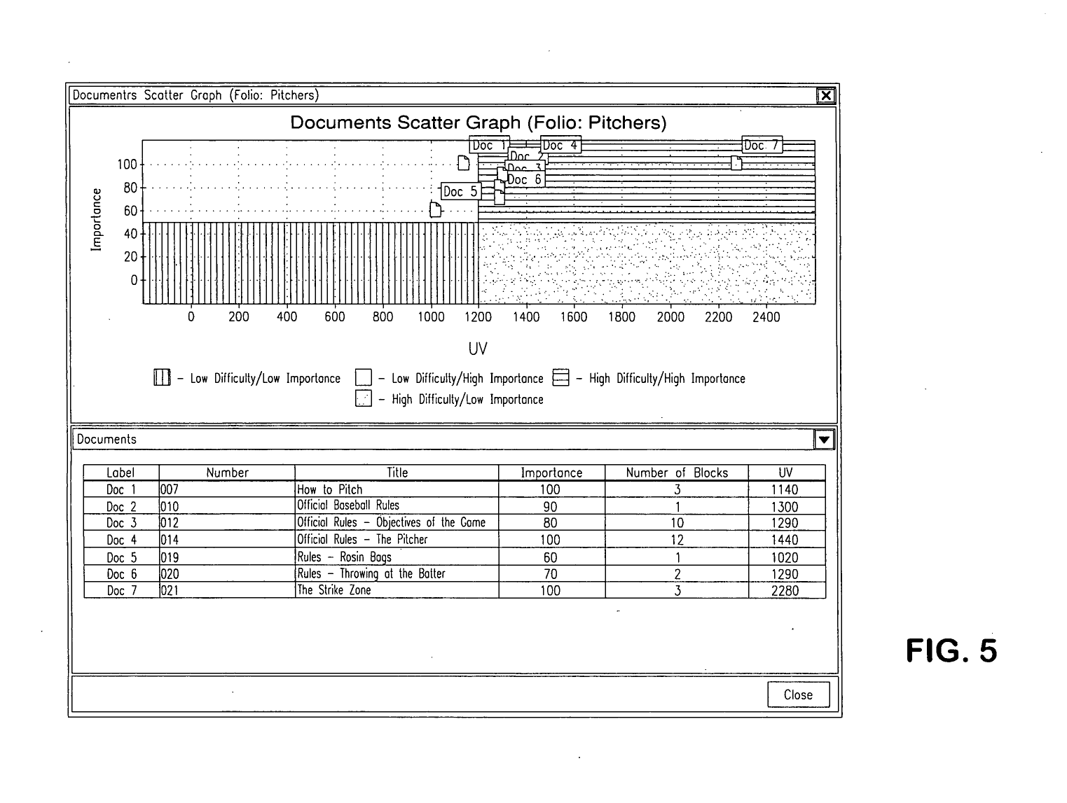

In block 304, each of the reading materials is assigned a numeric importance or weight. For example, a user may input a numeric importance or weight for each of the reading materials by use of user interface 102. Therefore, a user can identify the reading materials that are more important in the set for the purpose of alignment analysis. FIG. 5 is a screen display image of a set of reading materials and their corresponding importance according to an embodiment of the subject matter described herein.

In block 306, readability function 108 can determine a weighted average readability level for the set of reading materials. The weighted average readability level can be determined based on the readability level and the numeric importance or weight assigned to each of the reading materials. In an example of determining the weighted average readability level, the numeric importance or weight for each of the reading materials can be multiplied by the readability level of the corresponding reading material. The result of these multiplications can be totaled and divided by the number of reading materials to result in the weighted average readability level.

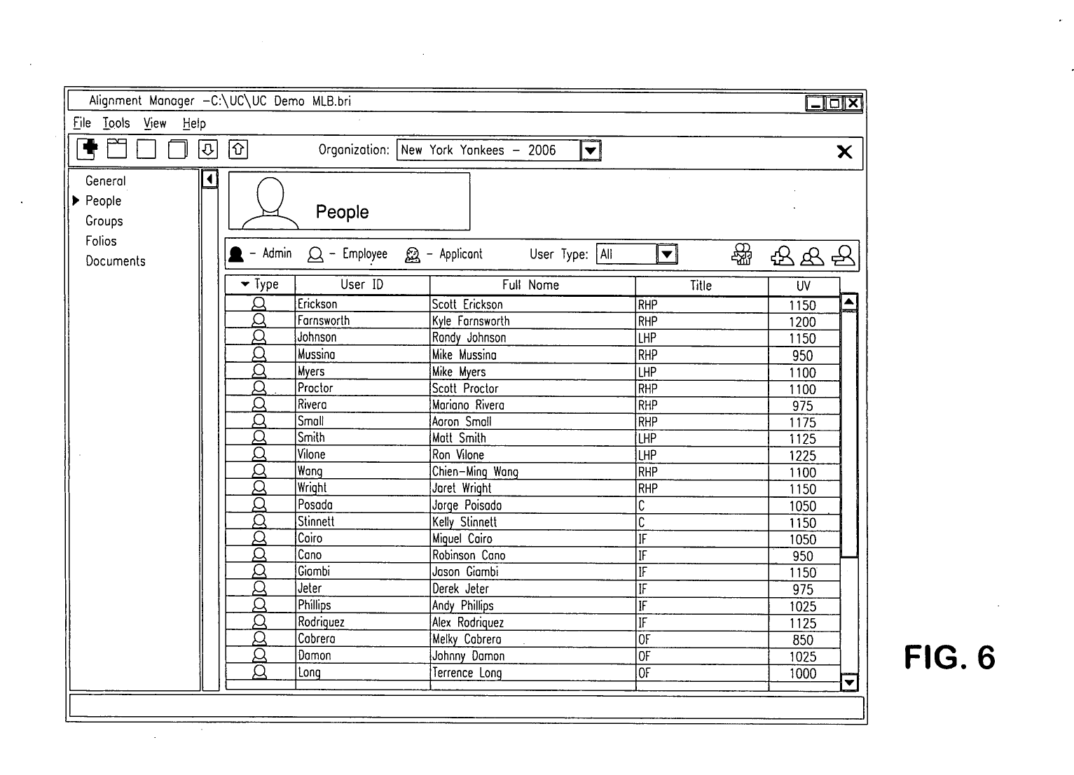

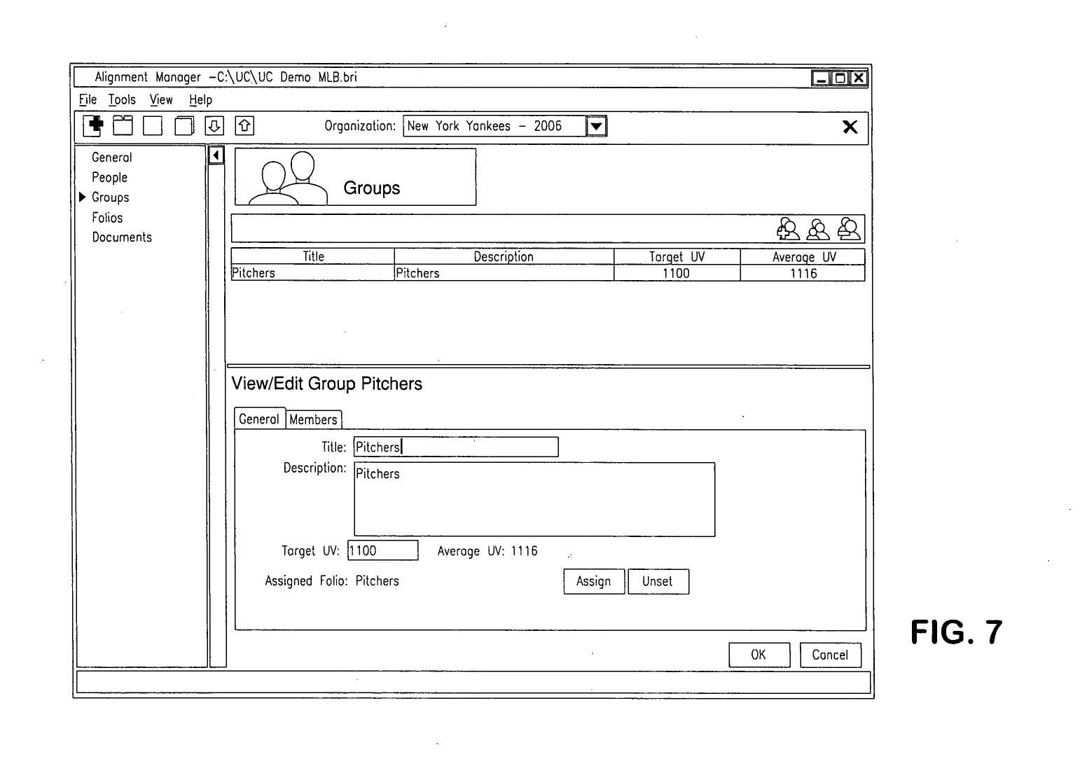

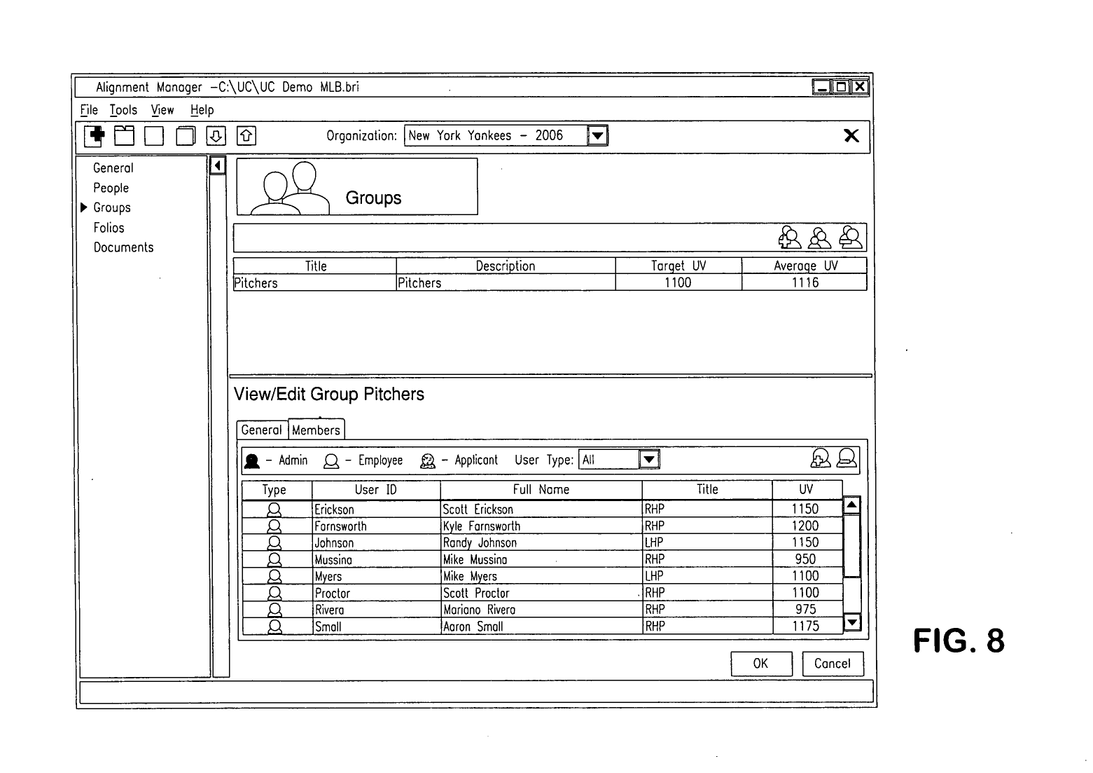

In block 308, a set of people defined to be the target audience can be identified. In one example, a list of people can be stored in a database. By use of user interface 102, a user can select people from the list to be the target audience. The selected people can be presented to a user via user interface 102. FIG. 6 is a screen display image of a list of people that can be selected in accordance with the subject matter described herein. The list of people can be grouped together and associated with the target audience reading level. FIG. 7 is a screen display image of a name of a group of people and associated target audience reading level according to an embodiment of the subject matter described herein. The members of the group can be edited as shown in the screen display image of FIG. 8.

An average reading level for the target audience can be determined (block 310). Readability function 108 can be configured for determining the average reading level for the target audience. For example, the reading level for each person can be determined using any suitable reading level test as described herein. A reading level for each person can be determined using any suitable technique as described herein. Next, the reading levels can be averaged to result in the average reading level for the target audience. The average reading level can be used to determine the target level for any text that is to be read by the target audience. The target level can be determined from the average level by any means, such as plus or minus a fixed predetermined value, plus or minus some multiple of the standard deviation, and any other quantity derived from the average level by any suitable means or formula.

A target audience reading level can be determined (block 312). Readability function 108 can be configured for determining the target audience reading level. For example, the target audience reading level may be the average reading level for the target audience determined in block 310. Alternatively, the target audience reading level may be determined using any suitable alternative technique. In one alternative, a “casual reading level” may be computed by multiplying the average reading level by a user-selected percentage less than 100. In another alternative, an “assisted reading level” may be determined by multiplying the average reading level by a user-selected percentage greater than 100. The subject matter described herein can apply to any such computed, estimated, or adjusted target audience reading level.

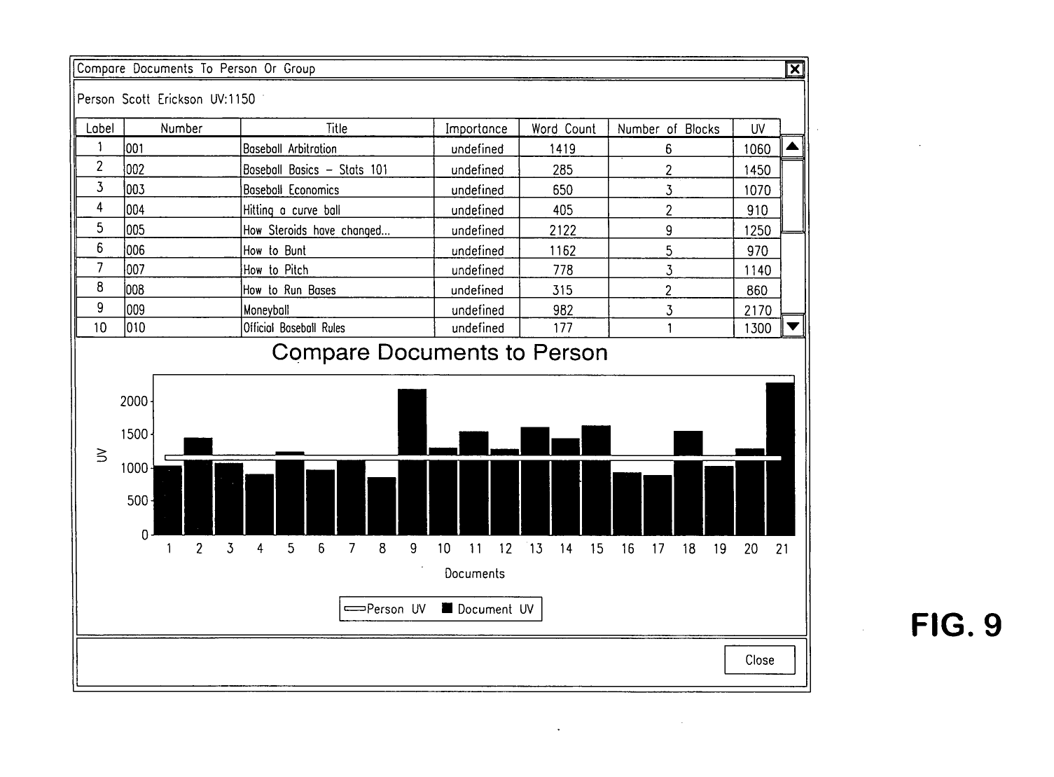

In block 314, readability function 108 can compare the measured readability level of each of the reading materials to the target audience reading level. Each reading material can be identified that has a readability level that is greater than the target audience reading level (block 316). Identified reading materials can be listed in a prioritized order using the weights or importance assigned in block 304. FIG. 9 is a screen display image of a comparison of reading material to a group and its members in accordance with the subject matter described herein. The identified reading materials can be presented to a user via user interface 102. If no reading materials are identified, the process can stop.

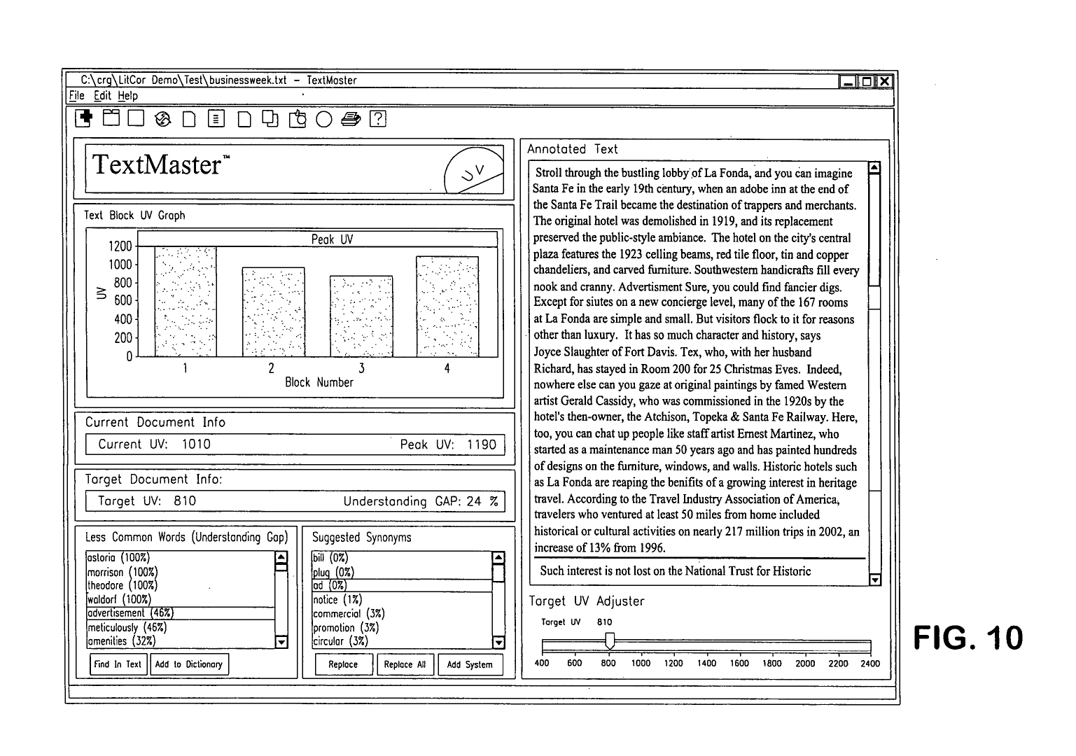

In block 318, the identified reading material can be revised. For example, the identified reading material can be presented to a user and the user can revise the reading material using user interface 102. In accordance with the techniques described herein, parameters and/or portions of the reading material can be identified that need revision to adjust the readability level of the reading material to the target audience reading level. FIG. 10 is a screen display image showing identifying portions of reading material that may be revised for adjusting a readability level according to an embodiment of the subject matter described herein. Revisions may continue until the readability level of the identified reading material are within a desired reading level.

In accordance with the subject matter described herein, reading material can be analyzed based on a target readability level and one or more other techniques for measuring the readability material. As set forth above, a readability level of reading material can be determined and presented to a user. In one example, the readability level may be determined in accordance with the hand scoring services provided by Measurement, Inc., of Durham, N.C. The reading material can be communicated to servers operated by Measurement, Inc. via an Internet connection. The Measurement, Inc. servers can determine a score value based on the readability of the material and return the score value via the Internet connection. A readability level on a scale from 1-3000 can be determined based on the returned score value. In one example, the returned score value is on a scale of 1-6, and the readability level can be converted to the 1-3000 scale by multiplying the returned score by 500. This score can be presented to a user along with other measures of the readability material.

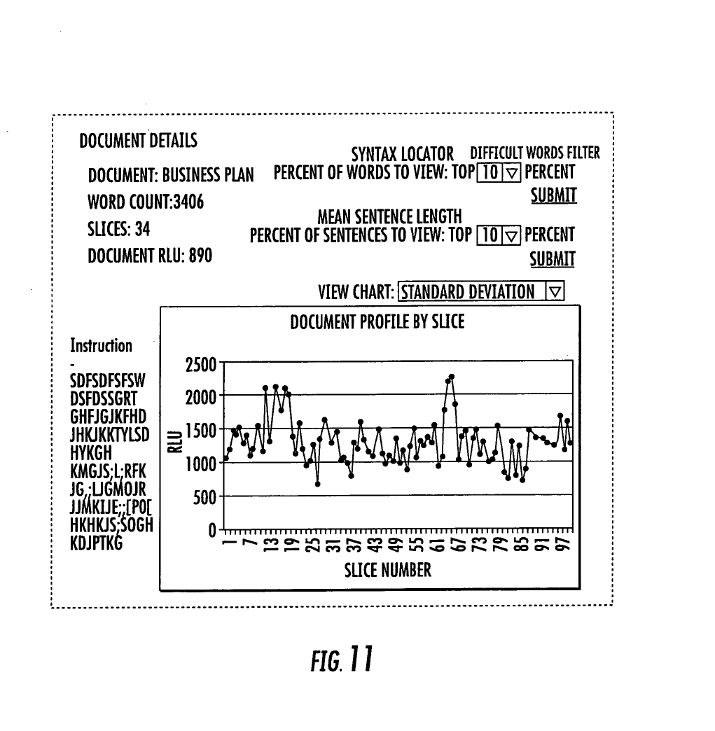

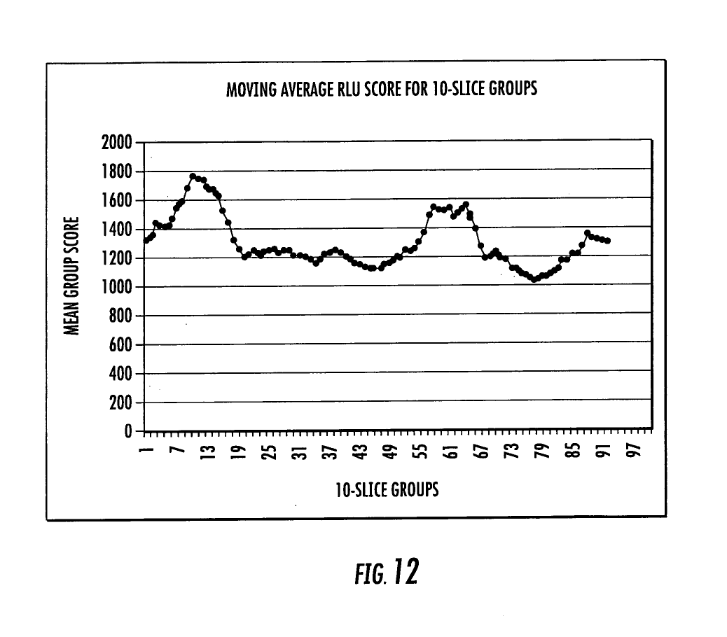

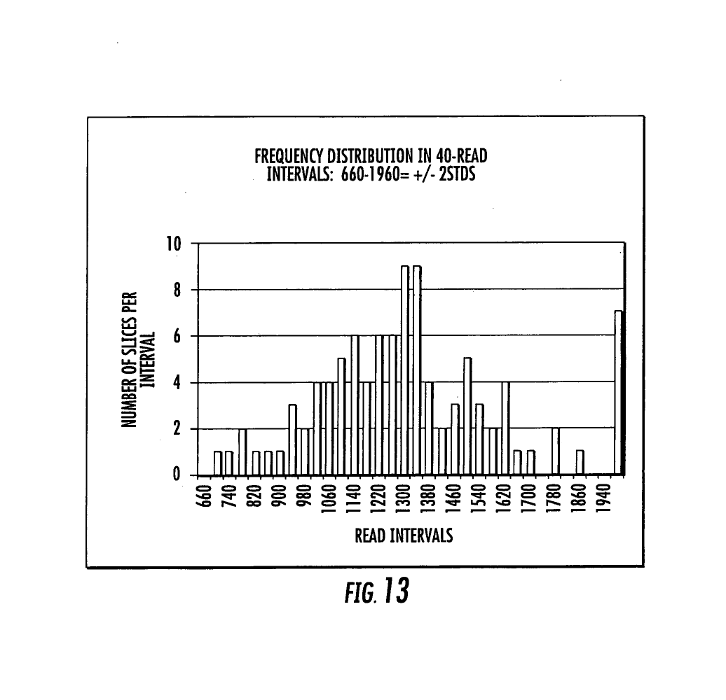

Readability measures that may be presented to a user include word count, slice evaluation data, difficult words filter results, and sentence evaluation results. The word count is a number indicating the number of words in the reading material. The slice evaluation data can include a slice plotting graph and a moving slice average. An exemplary slice plotting graph is illustrated in FIG. 11. The slice plotting graph is a graph visually presenting slices of the reading material and a readability value associated with each slice. A moving slice average combines slices into groups and provides a readability value for each. An exemplary moving slice average graph is illustrated in FIG. 12. A standard deviation chart can be provided for showing the number of slices above and below the average readability level for the reading material. An exemplary standard deviation chart is illustrated in FIG. 13. A syntax evaluator can identify difficult words and allow user input for selection of a percentage of difficult words to view.

In one example, a mean sentence locator can allow a user to assess the longest sentences in reading material. A drop down field can be provided to allow a user to select the percentage of long sentences to view. A list of the sentences can be provided and arranged from shortest to longest. The user can select one of the listed sentences and be taken to the sentence in the document through a popup page.

In one example, a readability level average can be presented for each slice of a reading material. This feature can allow a user to individually assess the readability of the slices. The readability level average can be un-weighted or weighted. An un-weighted average number can be the total number of slices divided by the readability level of the entire reading material. This process can be repeated for all of a plurality of related reading materials. The number of slices for all of the related reading materials can be added. The total readability level values for all of the reading materials can then be divided against the total number of slices.

In one example of an un-weighted readability level average, two documents are selected for obtaining an un-weighted readability level average. The first document has priority level 10, a readability level of 1000, and 10 slices. The second document has priority level 1, a readability level of 2000, and 20 slices. Initially, for the first document, the number of slices 10 is multiplied by the readability level 1000 to result in 10,000. For the second document, the number of slices 20 is multiplied by the readability level 2000 to result in 40,000. The total readability level of the documents is 10,000+40,000=50,000. Next, the total readability level 50,000 is divided by the total number of slices 30 to result in an un-weighted readability level of 1667 as the un-weighted readability level average for the documents.

A weighted readability average number can be the total number of priority levels assigned to slices, multiplied by the total number of slices, and multiplied by the readability level of the reading material. This process can be repeated for all of a plurality of related reading materials. Next, the priority/slice total can be multiplied by the readability level values for all of the reading materials. The priority/slices number for each of the reading materials can be added to obtain a total for the entirety of the related reading materials. Next, this number can be divided by the priority/slice number.

In one example of a weighted readability level average, two documents are selected for obtaining a weighted readability level average. The first document has priority level 10, a readability level of 1000, and 10 slices. The second document has priority level 1, a readability level of 2000, and 20 slices. For the first document, the priority level 10 is multiplied by the number of slices 10 to result in 100. The result 100 is multiplied by the readability level 1000 for the first document to result in 100,000. For the second document, the priority level 1 is multiplied by the number of slices 20 to result in 20. The result 20 is multiplied by the readability level 2000 for the second document to result in 40,000. The total of 100,000+40,000=140,000 is divided by the total of the results 100+20 to result in 1166 as the weighted readability level average for the two documents.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for adjusting readability of reading material to a target readability level, the method comprising:
(a) receiving reading material and a target readability level;
(b) determining first and second readability measures associated with the reading material;
(c) determining a target value corresponding to at least one of the first and second readability measures and based on the target readability level and the other of the first and second readability measures; and
(d) identifying a parameter or portion of the reading material being associated with the at least one of the first and second readability measures and having an actual readability value with a predetermined relationship with the target value.

2. The method of claim 1 wherein receiving reading material comprises receiving at least one of electronic and hard copy text materials, books, manuals, magazines, newspapers, word process documents, web page documents, and email.

3. The method of claim 1 wherein receiving a target readability level comprises receiving a numeric value representing a target readability level.

4. The method of claim 1 wherein determining first and second readability measures associated with the reading material comprises determining two or more of the group consisting of: number of syllables in a word and/or sentence, number of grammatical errors, number or proportion of misspelled words, number or proportion of unfamiliar words, number or proportion of inappropriate or misused words, number of paragraphs, number of sentences, number of words, number or proportion of foreign language words, measure of correct or incorrect punctuation, proportion of white space, proportion of non-textual elements, measure of writing style, and word frequency.

5. The method of claim 1 wherein determining a target value comprises applying an equation relating the target readability level to the first and second readability measures.

6. The method of claim 5 wherein applying an equation relating the target readability level to the first and second readability measures comprises solving the equation for the target value by use of the received target readability level and the other of the first and second readability measures.

7. The method of claim 6 wherein solving the equation for the target value comprises applying one of a linear search technique and a bisection algorithm.

8. The method of claim 1 wherein identifying a parameter or portion of the reading material comprises identifying the parameter or portion of the reading material having an actual readability value greater than the target value.

9. The method of claim 1 comprising presenting the identified parameter or portion of the reading material via a user interface.

10. The method of claim 1 wherein presenting the identified parameter or portion of the reading material comprises displaying the identified parameter or portion via a display.

11. The method of claim 1 comprising receiving revisions of the reading material.

12. The method of claim 11 wherein receiving revisions of the reading material comprises receiving revisions of the identified parameter or portion of the reading material.

13. The method of claim 11 comprising determining a readability level of the reading material.

14. The method of claim 13 wherein determining a readability level of the reading material includes applying to the reading material at least one of an Flesch Readability Index, a Flesch-Kincaid Grade Level, an Fog Index, a Bormuth Grade Level Readability Score, and a Lexile Framework for Reading.

15. The method of claim 11 wherein receiving revisions of the reading material comprises adjusting the identified parameter or portion of the reading material such that the actual readability value has an acceptable relationship with the target value.

16. A method for adjusting readability of a plurality of reading materials to a target reading level, the method comprising:
(a) receiving a set of reading materials;
(b) determining a reading level of a target audience;
(c) comparing a readability level of each of the reading materials to the reading level of the target audience; and
(d) identifying at least one of the reading materials with a readability level having a predetermined relationship with the reading level of the target audience.

17. The method of claim 16 wherein receiving a set of reading materials comprises receiving at least one of electronic and hard copy text materials, books, manuals, magazines, newspapers, word process documents, web page documents, and email.

18. The method of claim 16 wherein determining a reading level of a target audience includes determining an average reading level of the target audience.

19. The method of claim 16 wherein identifying at least one of the reading materials comprises identifying at least one of the reading materials having a predetermined relationship that is greater than the reading level of the target audience.

20. The method of claim 16 comprising determining the readability level of each of the reading materials.

21. A system for adjusting readability of reading material to a target readability level, the system comprising:
(a) a memory configured to store reading material and a target readability level; and
(b) a readability function configured to:
(i) determine first and second readability measures associated with the reading material;
(ii) determine a target value corresponding to at least one of the first and second readability measures and based on the target readability level and on the other of the first and second readability measures; and
(iii) identify a parameter or portion of the reading material being associated with the at least one of the first and second readability measures and having an actual readability value with a predetermined relationship with the target value.

22. The system of claim 21 wherein the memory is configured to store at least one of electronic and hard copy scans of text materials, books, manuals, magazines, newspapers, word process documents, web page documents, and email.

23. The system of claim 21 wherein the memory is configured to store a numeric value representing a target readability level.

24. The system of claim 21 wherein the readability function is configured to determine two or more of the group consisting of: number of syllables in a word and/or sentence, number of grammatical errors, number or proportion of misspelled words, number or proportion of unfamiliar words, number or proportion of inappropriate or misused words, number of paragraphs, number of sentences, number of words, number or proportion of foreign language words, measure of correct or incorrect punctuation, proportion of white space, proportion of non-textual elements, measure of writing style, and word frequency.

25. The system of claim 21 wherein the readability function is configured to apply an equation relating the target readability level to the first and second readability measures.

26. The system of claim 25 wherein the readability function is configured to solve the equation for the target value by use of the received target readability level and the other of the first and second readability measures.

27. The system of claim 26 wherein the readability function is configured to apply one of a linear search technique and a bisection algorithm.

28. The system of claim 21 wherein the readability function is configured to identify the parameter or portion of the reading material having an actual readability value greater than the target value.

29. The system of claim 21 wherein the readability function is configured to present the identified parameter or portion of the reading material via a user interface.

30. The system of claim 21 wherein the readability function is configured to display the identified parameter or portion via a display.

31. The system of claim 21 the readability function is configured to receive revisions of the reading material.

32. The system of claim 31 wherein the readability function is configured to receive revisions of the identified parameter or portion of the reading material.

33. The system of claim 31 wherein the readability function is configured to determine a readability level of the reading material.

34. The system of claim 33 wherein the readability function is configured to apply to the reading material at least one of an Flesch Readability Index, a Flesch-Kincaid Grade Level, an Fog Index, a Bormuth Grade Level Readability Score, and a Lexile Framework for Reading.

35. The system of claim 31 wherein the readability function is configured to adjust the identified parameter or portion of the reading material such that the actual readability value has an acceptable relationship with the target value.

36. A system for adjusting readability of a plurality of reading materials to a target reading level, the system comprising:
(a) a memory configured to store a set of reading materials;
(b) a readability function configured to:
(i) determine a reading level of a target audience;
(ii) compare a readability level of each of the reading materials to the reading level of the target audience; and
(iii) identify at least one of the reading materials with a readability level having a predetermined relationship with the reading level of the target audience.

37. The system of claim 36 wherein the memory is configured to store a set of reading materials comprises receiving at least one of electronic and hard copy text materials, books, manuals, magazines, newspapers, word process documents, web page documents, and email.

38. The system of claim 36 wherein the readability function is configured to determine an average reading level of the target audience.

39. The system of claim 36 wherein the readability function is configured to identify at least one of the reading materials having a predetermined relationship that is greater than the reading level of the target audience.

40. The system of claim 36 wherein the readability function is configured to determine the readability level of each of the reading materials.

41. A computer program product comprising computer executable instructions embodied in a computer readable medium for performing steps comprising:
(a) receiving reading material and a target readability level;
(b) determining first and second readability measures associated with the reading material;
(c) determining a target value corresponding to at least one of the first and second readability measures and based on the target readability level and the other of the first and second readability measures; and
(d) identifying a parameter or portion of the reading material being associated with the at least one of the first and second readability measures and having an actual readability value with a predetermined relationship with the target value.

42. The computer program product of claim 41 wherein receiving reading material comprises receiving at least one of electronic and hard copy text materials, books, manuals, magazines, newspapers, word process documents, web page documents, and email.

43. The computer program product of claim 41 wherein receiving a target readability level comprises receiving a numeric value representing a target readability level.

44. The computer program product of claim 41 wherein determining first and second readability measures associated with the reading material comprises determining two or more of the group consisting of: number of syllables in a word and/or sentence, number of grammatical errors, number or proportion of misspelled words, number or proportion of unfamiliar words, number or proportion of inappropriate or misused words, number of paragraphs, number of sentences, number of words, number or proportion of foreign language words, measure of correct or incorrect punctuation, proportion of white space, proportion of non-textual elements, measure of writing style, and word frequency.

45. The computer program product of claim 41 wherein determining a target value comprises applying an equation relating the target readability level to the first and second readability measures.

46. The computer program product of claim 45 wherein applying an equation relating the target readability level to the first and second readability measures comprises solving the equation for the target value by use of the received target readability level and the other of the first and second readability measures.

47. The computer program product of claim 46 wherein solving the equation for the target value comprises applying one of a linear search technique and a bisection algorithm.

48. The computer program product of claim 41 wherein identifying a parameter or portion of the reading material comprises identifying the parameter or portion of the reading material having an actual readability value greater than the target value.

49. The computer program product of claim 41 comprising presenting the identified parameter or portion of the reading material via a user interface.

50. The computer program product of claim 41 wherein presenting the identified parameter or portion of the reading material comprises displaying the identified parameter or portion via a display.

51. The computer program product of claim 41 comprising receiving revisions of the reading material.

52. The computer program product of claim 51 wherein receiving revisions of the reading material comprises receiving revisions of the identified parameter or portion of the reading material.

53. The computer program product of claim 51 comprising determining a readability level of the reading material.

54. The computer program product of claim 53 wherein determining a readability level of the reading material includes applying to the reading material at least one of an Flesch Readability Index, a Flesch-Kincaid Grade Level, an Fog Index, a Bormuth Grade Level Readability Score, and a Lexile Framework for Reading.

55. The computer program product of claim 51 wherein receiving revisions of the reading material comprises adjusting the identified parameter or portion of the reading material such that the actual readability value has an acceptable relationship with the target value.

56. A computer program product comprising computer executable instructions embodied in a computer readable medium for performing steps comprising:
(a) receiving a set of reading materials;
(b) determining a reading level of a target audience;
(c) comparing a readability level of each of the reading materials to the reading level of the target audience; and
(d) identifying at least one of the reading materials with a readability level having a predetermined relationship with the reading level of the target audience.

57. The computer program product of claim 56 wherein receiving a set of reading materials comprises receiving at least one of electronic and hard copy text materials, books, manuals, magazines, newspapers, word process documents, web page documents, and email.

58. The computer program product of claim 56 wherein determining a reading level of a target audience includes determining an average reading level of the target audience.

59. The computer program product of claim 56 wherein identifying at least one of the reading materials comprises identifying at least one of the reading materials having a predetermined relationship that is greater than the reading level of the target audience.

60. The computer program product of claim 56 comprising determining the readability level of each of the reading materials.
